(19) United States
(12) Patent Application Publication
(10) Pub. No.: US 2007/0113185 A1
(43) Pub. Date: May 17, 2007

(54) Intelligent network diagram layout

(75) Inventors: Stewart P. MacLeod, Woodinville, WA (US); Felix W. Wong, Bellevue, WA (US); Joe Coulombe, Woodinville, WA (US); Perry J. Owen, Woodinville, WA (US); M. Osman Mohiuddin, Redmond, WA (US); Kalpesh S. Patel, Redmond, WA (US); Paul M. Pottorff, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/280,472

(22) Filed: Nov. 16, 2005

(51) Int. Cl. G06F 17/00

(52) U.S. Cl. 715/734

(57) ABSTRACT

Various technologies and techniques are disclosed that improve the creation of diagrams. The user can select an option to create a diagram based on existing inventory, such as a network inventory. Details about the inventory are retrieved from one or more databases and/or files. The diagram is laid out in a snaking S tree to increase the number of attach points for a given diagram size. Each node on the diagram can include a graphic that represents a type, such as a machine type, and a label that summarizes the most important properties. Different graphics are used to represent different types of inventory, such as network equipment. To reduce clutter on the diagram, some inventory is grouped together on a single node to represent multiple pieces of the same type of inventory. The diagram can be submitted to other software programs for further analysis of the data contained therein.

### BACKGROUND

Companies can have hundreds of servers, workstations, mobile devices and network devices. Various diagramming tools exist that allow users to model network architectures. Some diagramming tools are able to generate a network architecture diagram automatically from retrieving network inventory information from a database. Diagrams that contain dozens or hundreds of nodes are difficult to read and even harder to maintain.

Traditional tree layouts are frequently used in diagrams. With a tree layout, most of the page is taken up with the lines, as opposed to the data itself. Other diagrams are created in a rectilinear fashion, which can cause line crossing problems and be hard to read. To avoid these line crossing issues, diagrams are often created using a radial tree layout algorithm. Radial tree layouts use what is called a focus plus context (fisheye) technique for visualizing and manipulating large hierarchies. The focused node is placed in the center of the display and all other nodes are rendered on appropriate circular levels around that selected node. The further away a node is from the center, the smaller it is rendered. Very large hierarchies can be displayed using this radial tree layout. However, the problem with the radial tree layout is that you have to work with the diagram electronically to zoom in and zoom out of various parts of the hierarchy in order to review more details about the nodes. Furthermore, you cannot see a big picture view of the entire diagram that includes meaningful details.

### SUMMARY

Various technologies and techniques are disclosed that improve the creation of diagrams. The user can select an option to create a diagram based on existing inventory, such as a network inventory. Details about the inventory are retrieved from one or more databases and/or files. The diagram is laid out in a snaking S tree to increase the number of attach points for a given diagram size. Each node on the diagram can include a graphic that represents a type, such as a machine type, and a label that summarizes the most important properties. Different graphics are used to represent different types of inventory, such as network equipment. Non-limiting examples of network equipment include servers, blades, appliances, wireless access points, firewalls, routers, and so on. To reduce clutter on the diagram, some inventory is grouped together on a single node to represent multiple pieces of the same type of inventory. As one non-limiting example, a single node can be used to represent all of the client workstations on a particular subnet. The diagram can be submitted to other software programs for further analysis of the data contained therein, such as to a software program that evaluates licensing compliance or a program that analyzes security.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a diagramming program operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved summarizing the information and grouping like items together to reduce the number of nodes on the diagram.

FIG. 5 is a process flow diagram for one implementation of the system of FIG. 1 illustrating the stages involved in generating a diagram in a snaking S tree fashion.

FIG. 6 is a simulated diagram for one implementation of the system of FIG. 1 that illustrates a diagram representing a current network architecture.

FIG. 7 is a simulated diagram for one implementation of the system of FIG. 1 that illustrates diagram representing a proposed network architecture.

FIG. 8 is a simulated screen for one implementation of the system of FIG. 1 that illustrates a diagram representing a current network architecture displayed to the user in a user interface.

FIG. 9 is a simulated screen for one implementation of the system of FIG. 1 that illustrates a diagram with a group that has been expanded to reveal additional details.

FIG. 10 is a simulated screen for one implementation of the system of FIG. 1 that illustrates a diagram representing a proposed network architecture displayed to the user in a user interface.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that improves the creation of diagrams, but the system also serves other purposes in addition to these. One or more of the techniques described herein can be implemented as features within a diagramming software program such as MICROSOFT® Office VISIO®, Autocad, or from any other type of program or service that allows creation of diagrams. As described in further detail herein, in one implementation of the system, diagrams are created in a snaking S tree to increase the number of attach points for a given diagram size. In another implementation, each node on the diagram includes a graphic and corresponding text that describes the equipment represented on the node. In yet another implementation, equipment is aggregated based on processor type, count, memory, installed software, and/or server role to reduce the total number of nodes depicted on the diagram.

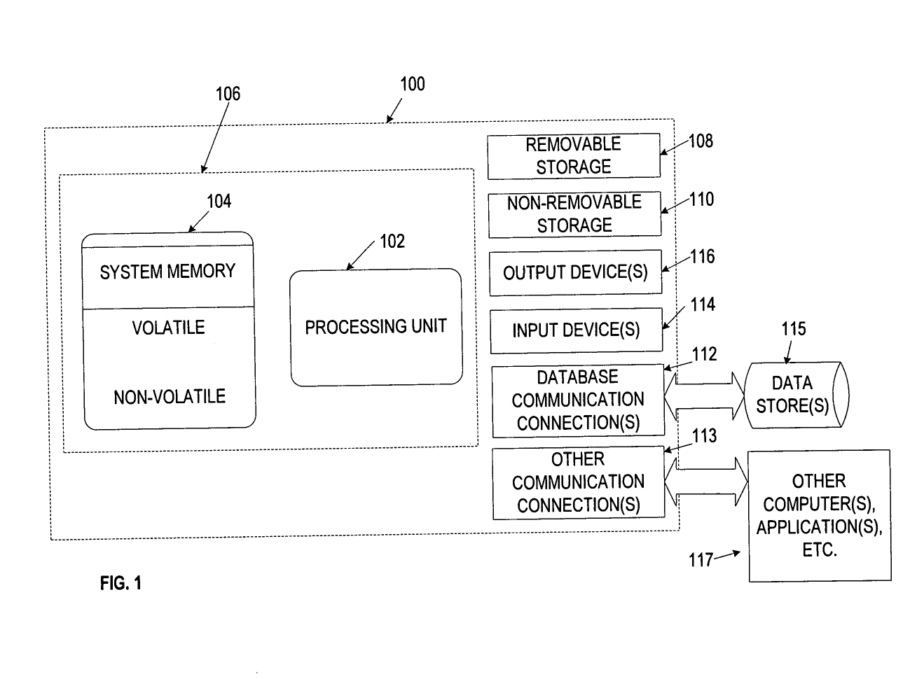

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 110 includes one or more database communication connections that allow computing device 112 to communicate with one or more data stores 115. Alternatively or additionally to database communication connection(s) 112, device 100 may contain other communications connection(s) 113 that allow the device to communicate with other devices. Communications connection(s) 112 and 113 are examples of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. Output device(s) 116 such as a display, speakers, printer, etc. may also be included. These devices are well known in the art and need not be discussed at length here.

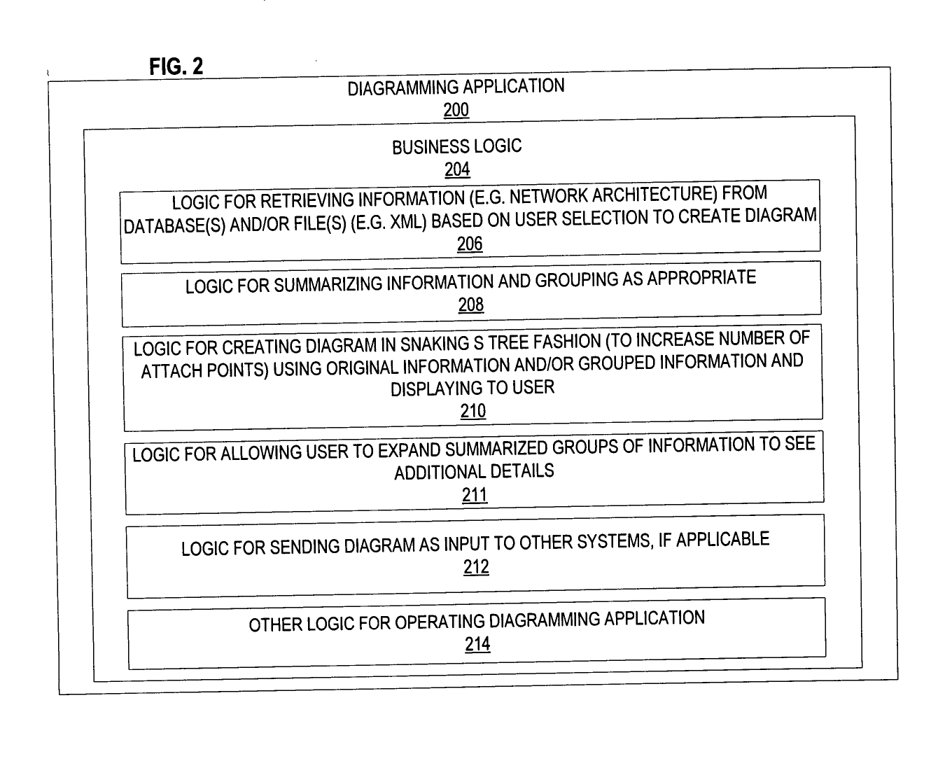

Turning now to FIG. 2 with continued reference to FIG. 1, a diagramming application 200 operating on computing device 100 is illustrated. Diagramming application 200 is one of the application programs that reside on computing device 100. Alternatively or additionally, one or more parts of diagramming application 200 can be part of system memory 104, on other computers and/or applications 117, or other such variations as would occur to one in the computer software art.

Diagramming application 200 includes business logic 204, which is responsible for carrying out some or all of the techniques described herein. Business logic 204 includes logic for retrieving information (e.g. network architecture) from database(s) and/or file(s) (e.g. xml) based on user selection to create a diagram 206, logic for summarizing information and grouping as appropriate 208, logic for creating diagram in snaking s tree fashion (to increase number of attach points) using original information and/or grouped information and displaying to user 210, logic for allowing user to expand summarized groups of information to see additional details 211, logic for sending diagram as input to other systems 212, and other logic for operating diagramming application 214. In one implementation, business logic 204 is operable to be called programmatically from another program, such as using a single call to a procedure in business logic 204.

In FIG. 2, business logic 204 is shown to reside on computing device 100. However, it will be understood that business logic 204 can alternatively or additionally be embodied as computer-executable instructions on one or more computers and/or in different variations than shown on FIG. 2. As one non-limiting example, one or more parts of business logic 204 could alternatively or additionally be implemented as an XML web service that resides on an external computer that is called when needed.

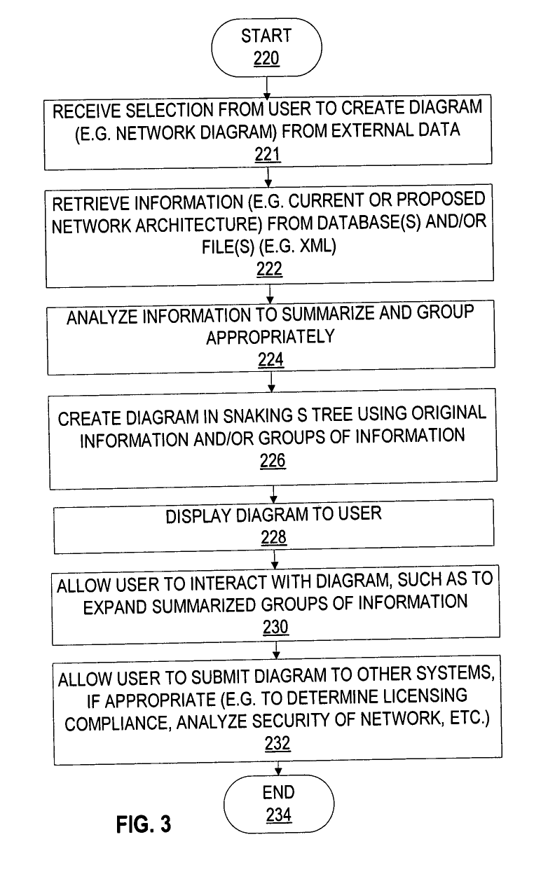

Turning now to FIGS. 3-5 with continued reference to FIGS. 1-2, the stages for implementing one or more implementations of diagramming application 200 are described in further detail. FIG. 3 is a high level process flow diagram for diagramming application 200. In one form, the process of FIG. 3 is at least partially implemented in the operating logic of computing device 100. The procedure begins at start point 220 with receiving a selection from the user to create a diagram from external data sources (stage 221). In one implementation, the user selects an option to create a network diagram that will include one or more pieces of equipment present on a particular network. Diagramming application 200 executes business logic 206 to retrieve information from one or more databases and/or files on data store(s) 115 to create the diagram (stage 222). The diagram can be based on a current network architecture and/or a proposed network architecture, to name a few non-limiting examples.

Diagramming application 200 executes business logic 208 to analyze the information retrieved from data store(s) 115 and summarize and group the information appropriately (stage 224). Business logic 210 is executed to create a diagram using the original and/or grouped information in a snaking S tree format (stage 226). The completed diagram is displayed to the user (stage 228). The user is able to interact with the diagram, such as to expand the summarized groups of information to view more details (stage 230). The user can submit the diagram to other systems, such as licensing compliance tools, security analyzers (e.g. MICROSOFT® Baseline Security Analyzer), etc. (stage 232). The actual diagram itself can be submitted to the other software programs, and/or data can be saved from the diagram for submission to the other software programs. When the actual diagram itself is submitted to other software programs, those programs are able to read the data contained in the diagram for performing the further analysis. The process then ends at end point 234.

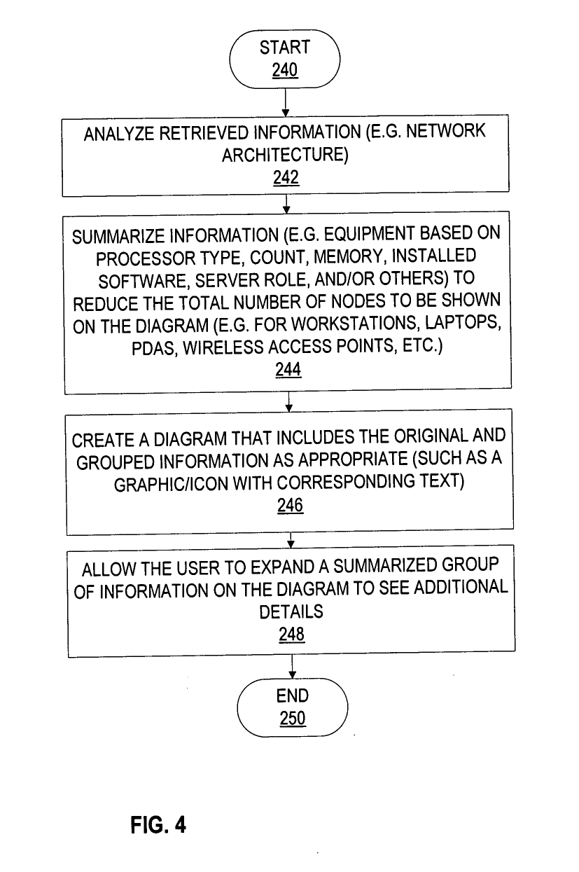

FIG. 4 illustrates the stages involved in summarizing the information and grouping like items together (e.g. intelligently aggregating them) to reduce the number of nodes on the diagram. In one form, the process of FIG. 4 is at least partially implemented in the operating logic of computing device 100. The procedure begins at start point 240 with analyzing the information retrieved from one or more data stores(s) 115 (stage 242). As one non-limiting example, the information is network architecture information. In one implementation, the network architecture information is retrieved from a central database that stores information about equipment on the particular network. This database is created from compiling data from various original data sources into a central database that can be used by diagramming application 200 to create the diagram. One example of an original data source includes a network directory data store with group policies and other security information about a plurality of computers and users on a particular network. An example of such a network directory data store is MICROSOFT® ACTIVE DIRECTORY®. Another non-limiting example of an original data store can include data that was gathered while scanning a particular network to look for computers that are connected. One or more original data sources can be used to obtain various information about the equipment present on a particular network for storing in the central database, which can then be used by diagramming application 200.

In another implementation, the network architecture information is retrieved directly by diagramming application 200 from these various original data sources when the user selects the option to create a new diagram. A combination of these two approaches can also be taken, such as to retrieve some information from a central data store containing network architecture information from other sources, and to retrieve other information from some original data sources directly.

The information is then analyzed (stage 242) and summarized to include one or more important properties and is grouped together appropriately to reduce the total number of nodes to be shown on the diagram (stage 244). In one implementation, the information includes one or more pieces of network equipment that are summarized by processor type, count, memory, installed software, server role, and/or other equipment-related settings. To reduce clutter on the diagram, some pieces of equipment are grouped together so just one representation for multiple pieces is shown. As a few non-limiting examples, client workstations, client laptops, client PDAs, and/or wireless access points that have multiple quantities may just be represented on the diagram once for their respective type on that particular node. Other variations are also possible, such as to group servers or other similar pieces of equipment together.

Diagramming application 200 then creates a diagram that includes the original and grouped information as appropriate (stage 246). Some information is displayed on the diagram in a grouped fashion, such as a single node representing multiple pieces of equipment. Other information is displayed as a node on the diagram to represent a single piece of equipment, such as a particular server. In one implementation, the information with one or more important properties is displayed on the diagram with a graphic or icon that represents the type of equipment it is. As a few non-limiting examples, the graphic may be a graphic of a server to represent a server, a graphic of a desktop to represent a desktop, a graphic of multiple desktops to represent multiple desktops, a graphic of a laptop to represent a laptop, a graphic of multiple laptops to represent multiple laptops, and so on. Other non-limiting examples of graphics can include blades, appliances, PDAs, switches, routers, firewalls, wireless access points, printers, file shares, and any other pieces of equipment that can be present on a particular network.

Alternatively or additionally, a text box or label is then displayed to explain the important properties for the respective type of equipment, such as the type of server and/or its IP address, the software installed, etc. In the case of a grouped node, the important properties can include a description that includes the number of the particular grouped item. When a graphic is used, the corresponding label that describes the graphic can be located near the graphic in a fashion so that it is clear they are related to each other. In one implementation, the user can expand a node that contains summarized groups of information to see additional details (stage 248). A non-limiting example of this might be to expand the node summarizing the grouped wireless access points to then see more details about each individual wireless access point. In one implementation, a new diagram showing the expanded details is created when the user selects the node to expand. In another implementation, the additional details are created as part of the initial diagram but are hidden from the user's view until the node to expand is selected by the user. Other ways to view more details about the summarized information can also be used. As one non-limiting example, a new type of diagram, called a pivot diagram, can be created to allow for analysis of data similar to spreadsheet pivot tables. The process then ends at end point 250.

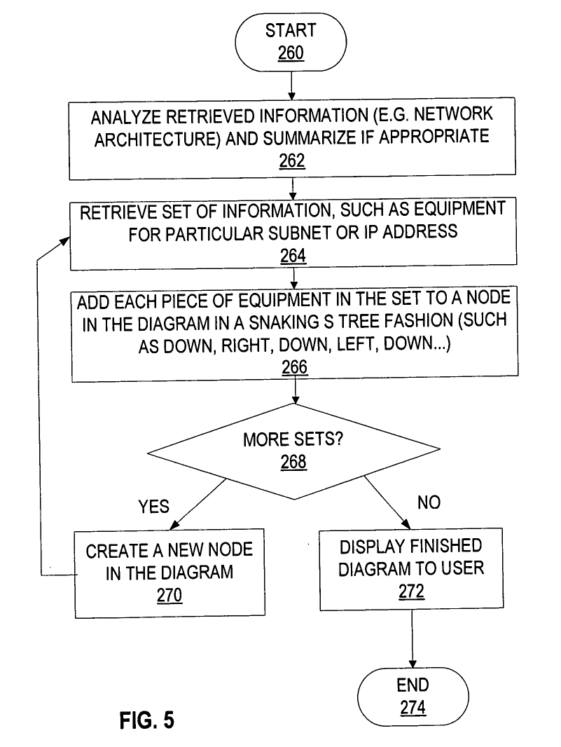

FIG. 5 illustrates the stages involved in generating a diagram in a snaking S tree fashion. In one form, the process of FIG. 5 is at least partially implemented in the operating logic of computing device 100. The process begins at start point 260 with analyzing the information retrieved from the data store(s) 115 and summarizing and grouping the information as appropriate (stage 262). A first set of the information is retrieved (stage 264). As a few non-limiting examples, the first set might include all of the equipment for a particular IP address or subnet.

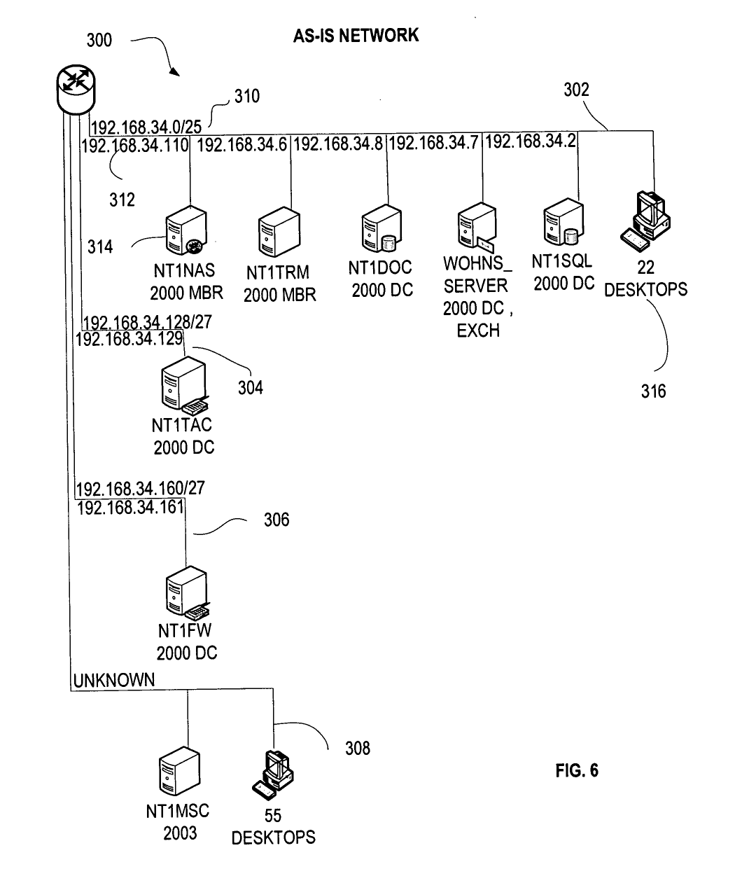

Each item of information in the first set (e.g. piece of equipment in a particular subnet) is added to a node in the diagram in a snaking S tree fashion (stage 266). An example how a snaking S tree diagram can be created includes drawing a line down, drawing a line right, drawing nodes off of the right line, drawing a line down, drawing a line left, drawing nodes off of the left line, and so on. Other directions which use a snaking S tree fashion could also be used, such as starting from right to left, starting with a left line, and so on. Alternatively or additionally, items can have secondary relationships to other items in the diagram, such as to illustrate a printer that is attached to a server, which is then attached to the network. FIGS. 6-10 graphically illustrate the snaking S tree fashion in further detail, and some example relationships. For each additional set of information (e.g. more sets of equipment in particular subnet) (decision point 268), stages 264 and 266 are repeated to retrieve the next set of information (stage 264) and create a new node in the diagram in the snaking S tree fashion for that next set (stage 266). Alternatively or additionally, each snaking S tree in the diagram can be optimized separately and/or can include multiple layout algorithms. The completed diagram is then displayed to the user (stage 272). The process then ends at end point 274.

Turning now to FIGS. 6-10, simulated diagrams and screens are shown to illustrate the stages described in FIGS. 3-5 in further detail. FIG. 6 shows a diagram 300 created using diagramming application 200 that represents a current “as-is” network. There are four subnets on diagram 300, including subnet 302, subnet 304, subnet 306, and subnet 308. The first subnet 302 is identified by a set of IP addresses 310, and then the actual IP address for each particular piece of equipment, where applicable, is displayed. For example, IP address 312 corresponds to server 314. Desktops 316 shows an example of equipment that have been grouped together to reduce the number of nodes. The number of desktops is shown in the corresponding label to the graphic illustrating multiple computers.

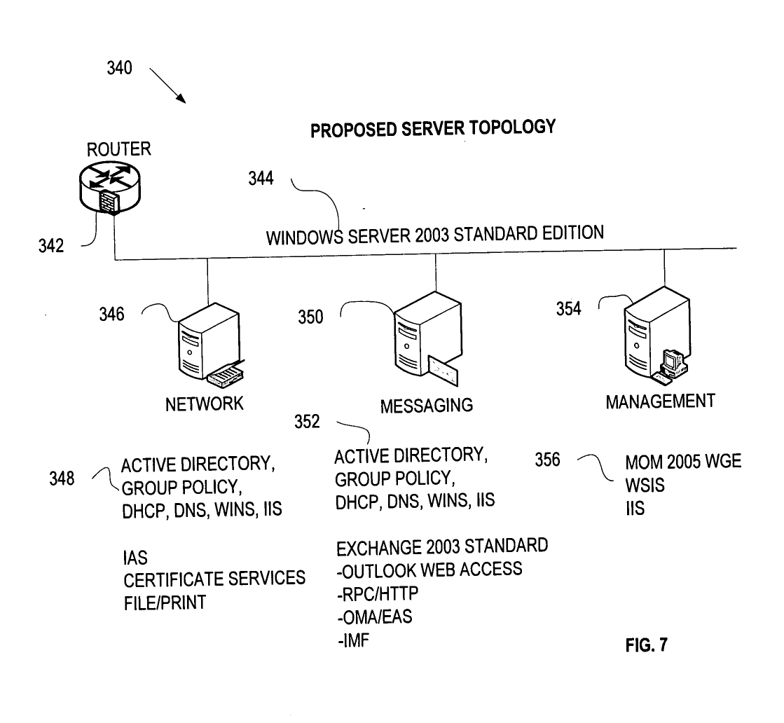

As shown in FIG. 7, a proposed network architecture diagram 340 created using diagramming application 200 is illustrated. Diagram 340 illustrates a router 342, the proposed operating system 344 for servers 346, 350, and 354. The recommended software (348, 352, and 354, respectively) is shown for each of corresponding servers 346, 350, and 354. Diagrams 300 and 340 on FIGS. 6 and 7 both use the snaking S tree format discussed in the process of FIG. 5 and the summarizing and grouping techniques discussed in the process of FIG. 4.

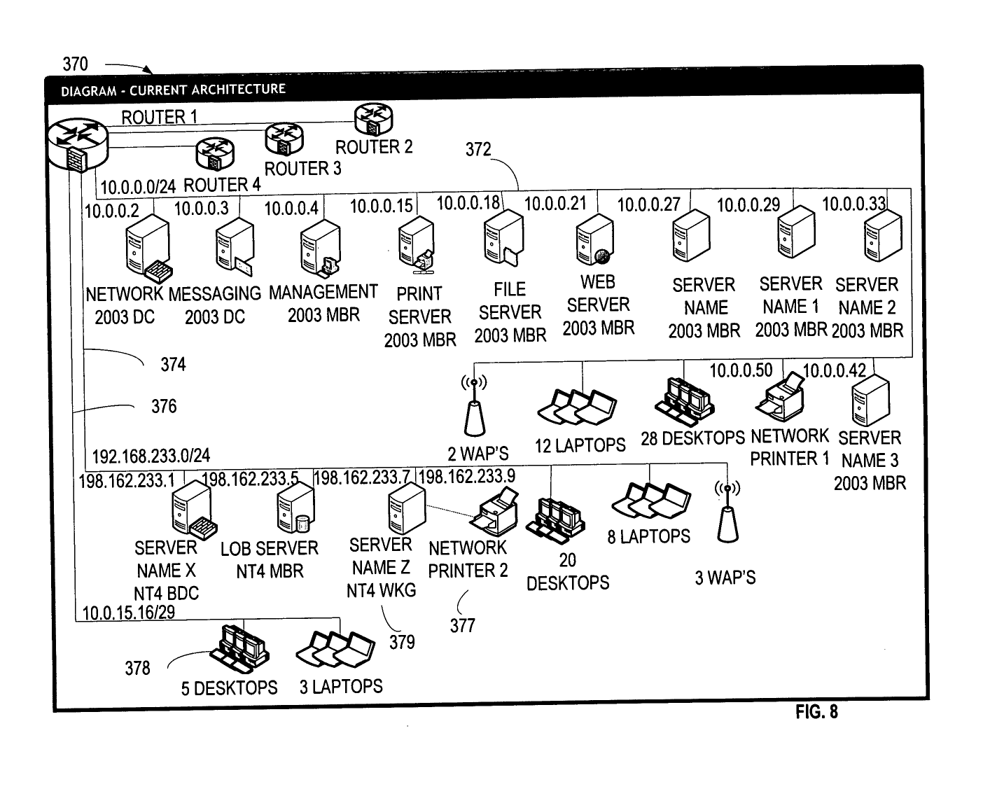

Turning now to FIG. 8-10, simulated screens are shown to illustrate a user interface that allows a user to view and interact with a diagram created using diagramming application 200. These screens can be displayed to users on output device(s) 116. Furthermore, these screens can receive input from users from input device(s) 114.

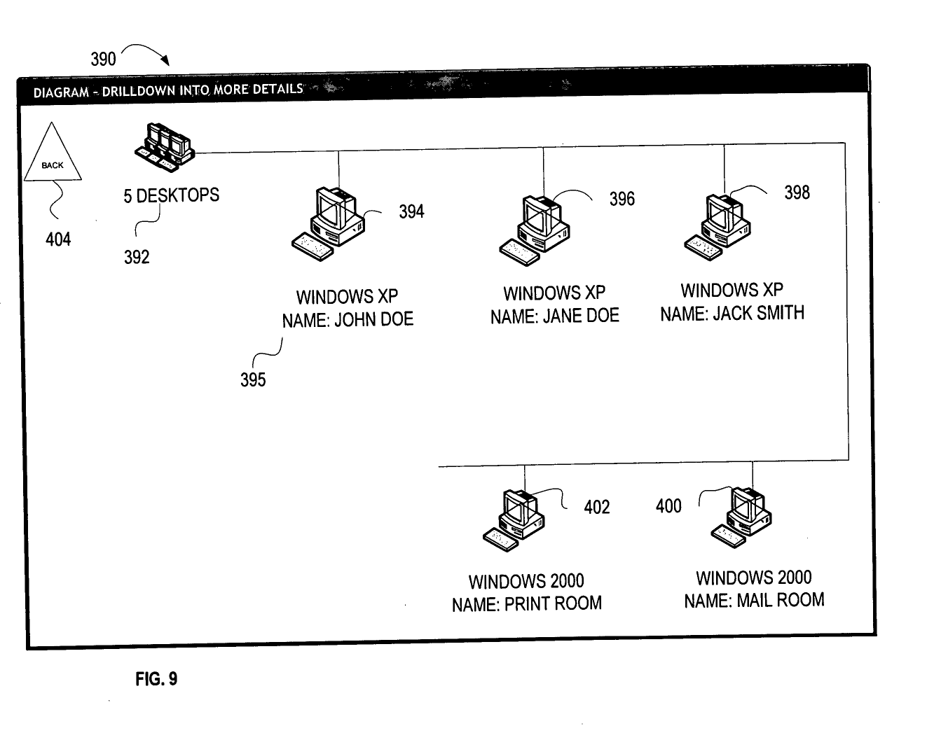

On FIG. 8, simulated screen 370 includes three subnets 372, 374, and 376. There are several servers represented on the diagram with additional details that summarize the servers. Printer 377 that is connected to server 379 illustrates an example of a secondary relationship between network equipment. Other network equipment is also shown, such as wireless access points, desktops, laptops, etc. These are examples of elements that were grouped together into a single graphic to reduce the number of nodes on the diagram. As one non-limiting example, graphic and label 378 are shown to illustrate that 5 desktops are present on subnet 376. In one implementation, the user can select graphic and label 378 to expand the view for additional details, such as shown in FIG. 9. In one implementation, a new diagram is created upon the user's selection of the node to expand. In another implementation, the expanded information is included when the initial diagram is created, but is hidden from the user's view until a node to expand is selected. Screen 390 of FIG. 9 shows an example of node 378 on FIG. 8 being expanded to display more details. Desktops 392 are shown at the top of the display, and then more details about each of the five computers 394, 396, 398, 400, and 402 are shown. For example, computer 394 is a computer running a MICROSOFT® WINDOWS® XP operating system that is used by John Doe, as shown on label 395. The user can select option 404 to return to screen 370 shown on FIG. 8.

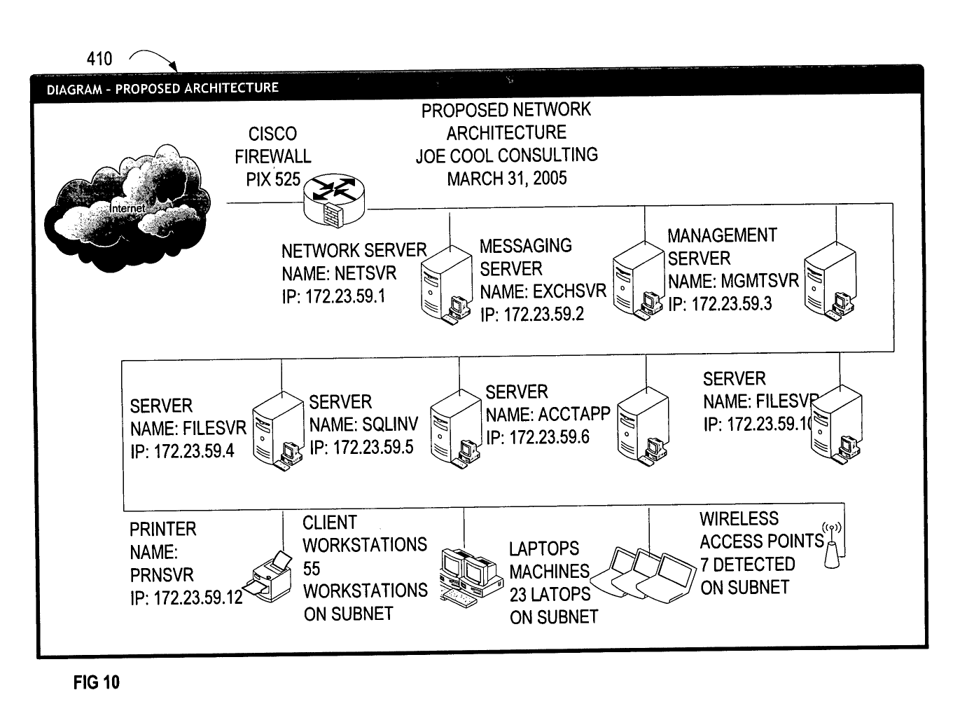

FIG. 10 includes a simulated screen 410 that illustrates a proposed network architecture. Simulated screen 410 is similar in layout to the previous screens. Simulated screens 370, 390, and 410 of FIG. 8-10 also use the snaking S tree format discussed in the process of FIG. 5 and the summarizing and grouping techniques discussed in the process of FIG. 4.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
receiving a selection from a user to create a diagram;
retrieving information from at least one data store to use for at least a portion of the diagram;
creating the diagram using a snaking S tree format for each of a plurality of subnets; and
displaying the diagram to the user.

2. The computer-readable medium of claim 1, wherein the creating the diagram step further comprises the step of: creating a computer network diagram.

3. The computer-readable medium of claim 1, wherein the creating the diagram step further comprises the step of: sorting the subnets by IP address.

4. The computer-readable medium of claim 1, wherein the creating the diagram step further comprises the steps of:
aggregating at least a portion of the retrieved information;
creating the diagram based on the retrieved information and the aggregated information; and
wherein the diagram includes a graphic and corresponding text for each of the plurality of subnets.

5. The computer-readable medium of claim 1, wherein the creating the diagram step further comprises the step of: grouping each of a plurality of similar pieces of network equipment together into a single node on the diagram.

6. A computer-readable medium having computer-executable instructions for causing a computer to perform steps comprising:
retrieving information from at least one data store to use for at least a portion of a diagram; and
creating the diagram based at least in part on the retrieved information, the creating the diagram step comprising the steps of:
including a corresponding graphic and a corresponding text for each of a plurality of nodes on a subnet, wherein the corresponding text describes one or more characteristics about a particular piece of equipment represented by the corresponding graphic; and
grouping together each of a plurality of similar pieces of equipment on a particular subnet of the plurality of subnets into a single node on the diagram to reduce clutter.

7. The computer-readable medium of claim 6, further comprising the step of:
receiving a selection from a user to expand a particular selected grouping of similar pieces; and
displaying additional details about the particular selected grouping.

8. The computer-readable medium of claim 6, wherein the corresponding graphic is selected from the group consisting of a server graphic, a blade graphic, an appliance graphic, a desktop graphic, a laptop graphic, a PDA graphic, a wireless access point graphic, a router graphic, a firewall graphic, a printer graphic, and a file server graphic.

9. The computer-readable medium of claim 6, wherein the corresponding text is selected from the group consisting of machine role, machine name, IP address, installed software, and quantity.

10. A method for improving the creation of network diagrams comprising the steps of:
retrieving information from at least one data store to use for at least a portion of a network diagram;
summarizing at least a portion of the information retrieved from the data store; and
creating the network diagram based on the retrieved information and the summarized information, the diagram including a graphic and corresponding text for each node on a plurality of subnets on the diagram.

11. The method of claim 10, wherein the network diagram is created in a snaking S tree format for each of the plurality of subnets.

12. The method of claim 10, wherein each of a plurality of similar pieces of network equipment are grouped together into a single node on the network diagram.

13. The method of claim 10, further comprising:
submitting the diagram to a software program so the software program can use the data in the diagram for a particular purpose.

14. The method of claim 10, wherein the software program is a licensing compliance program and wherein the particular purpose is to determine whether a particular network represented in the diagram complies with a set of licensing requirements.

15. The method of claim 10, wherein the software program is a security analyzer program and wherein the particular purpose is to determine one or more security vulnerabilities on a particular network represented in the diagram.

16. The method of claim 10, wherein the subnets are sorted by IP address.

17. The method of claim 10, wherein the data store is an XML file.

18. The method of claim 10, wherein the data store is a database including network architecture information that was compiled from a plurality of original data sources.

19. The method of claim 18, wherein at least one of the original data sources includes a network directory data store, the network directory data store having group policies and other security information about a plurality of computers and users on a particular network.

20. A computer-readable medium having computer-executable instructions for causing a computer to perform the steps recited in claim 10.
